(19) United States
(12) Patent Application Publication
(10) Pub. No.: US 2025/0165184 A1
(43) Pub. Date: May 22, 2025

(54) CONTROLLER, STORAGE DEVICE INCLUDING THE CONTROLLER, AND METHOD OF OPERATING THE STORAGE DEVICE

(71) Applicant: SK hynix Inc., Icheon-si (KR)

(72) Inventor: Yun Chan SEO, Icheon-si (KR)

(21) Appl. No.: 18/612,942

(22) Filed: Mar. 21, 2024

(30) Foreign Application Priority Data
Nov. 20, 2023 (KR) 10-2023-0160150

(51) Int. Cl. G06F 3/06

(52) U.S. Cl. CPC G06F 3/0659; G06F 3/0619; G06F 3/064; G06F 3/0683

(57) ABSTRACT

When writing user data to a memory, a data synchronization indicator is set to a page to which the user data is written, depending on whether a data synchronization command is received from a host device. A guarantee for the user data requested by the host device may be provided, and operation efficiency of a storage device may be improved by reducing unnecessary operations when controlling the operation of the storage device.

### CROSS-REFERENCE TO RELATED APPLICATION

The present application claims priority under 35 U.S.C. § 119(a) to Korean Patent Application No. 10-2023-0160150 filed in the Korean Intellectual Property Office on Nov. 20, 2023, which is incorporated herein by reference in its entirety.

### BACKGROUND

### 1. Technical Field

Various embodiments of the disclosed technology generally relate to a controller, a storage device including the controller, and a method for operating the storage device.

### 2. Related Art

A storage device may include at least one memory that includes a plurality of memory cells for storing data. The storage device may include a controller which controls operations of the at least one memory. The controller may control an operation of writing data to the memory or an operation of reading or erasing data stored in the memory.

As the case may be, a sudden power-off may occur during an operation of the storage device. Such a sudden power-off can compromise the reliability of operations performed in the storage device before the occurrence of the sudden power-off. Subsequent to the sudden power-off, a recovery operation addressing the effects of the sudden power-off may be required.

### SUMMARY

Various embodiments of the disclosed technology are directed to providing measures capable of efficiently performing a recovery operation, addressing the consequences of a sudden power-off that occurs in a storage device.

In an embodiment, a storage device may include: at least one memory including a plurality of word lines, a plurality of bit lines and a plurality of storage blocks; and a controller configured to write user data according to a write command to data areas of a plurality of pages included in each of the plurality of storage blocks, and write, when receiving a data synchronization command, a data synchronization indicator to a spare area of at least one page of the plurality of pages to which the user data is written.

In an embodiment, a storage device may include: a first memory; a second memory; and a controller configured to write, when receiving a write command, user data according to the write command to the first memory, write, when receiving a data synchronization command, the user data written to the first memory to the second memory, and write a data synchronization indicator to a page of the second memory where the user data is written.

In an embodiment, a storage device may include: at least one memory including a plurality of word lines, a plurality of bit lines and a plurality of storage blocks; and a controller configured to read, in recovery of a sudden power-off when the sudden power-off occurs, a spare area of a page corresponding to a last word line of a target storage block where user data is written, and copy, when a data synchronization indicator is written to the spare area, the user data written to a data area of the page including the spare area to a temporary storage block.

In an embodiment, a controller may include: a buffer memory; and a processor configured to write, when receiving a write command, user data according to the write command to the buffer memory, write, when receiving a data synchronization command, the user data written to the buffer memory to an external memory together with a data synchronization indicator, and write, when a total size of the user data written to the buffer memory before the data synchronization command is received is equal to or larger than a preset value, the user data written to the buffer memory to the external memory without the data synchronization indicator.

In an embodiment, a method for operating a storage device may include: writing user data to a first memory when a write command is received from a host device; writing, when receiving a data synchronization command from the host device, the user data written to the first memory to a data area of a page included in a second memory; and writing a data synchronization indicator to a spare area of the page including the data area to which the user data is written.

According to the embodiments of the disclosed technology, when a sudden power-off occurs in a storage device, a recovery operation can be efficiently performed, ensuring the maintenance of the reliability of data stored in the storage device.

### BRIEF DESCRIPTION OF THE DRAWINGS

FIG. 1 illustrates a schematic configuration of a storage device according to an embodiment of the disclosed technology.

FIG. 2 illustrates a schematic configuration of a memory illustrated in FIG. 1.

FIG. 3 illustrates an operation of writing data to a memory according to an embodiment of the disclosed technology.

FIGS. 4 and 5 illustrate an operation of writing data to a memory according to another embodiment of the disclosed technology.

FIGS. 6A to 6D illustrate examples of writing data to respective pages of a storage block included in a storage device according to an embodiment of the disclosed technology.

FIGS. 7 to 9 illustrate a recovery operation according to an embodiment of the disclosed technology.

FIGS. 10 and 11 are flowcharts illustrating a method of writing data to a memory according to an embodiment of the disclosed technology.

FIG. 12 is a flowchart illustrating a recovery operation according to an embodiment of the disclosed technology.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including,” “having,” “containing,” “constituting,” “make up of,” and “formed of” used herein are generally intended to allow other components to be added unless the terms are used with the term “only.” As used herein, singular forms are intended to include plural forms unless the context clearly indicates otherwise.

Terms, such as “first,” “second,” “A,” “B,” “(A),” or “(B)” may be used herein to describe elements of the present disclosure. Each of these terms is not used to define essence, order, sequence, or number of elements etc., but is used merely to distinguish the corresponding element from other elements.

When it is mentioned that a first element “is connected or coupled to,” “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to,” “contact or overlap”, etc. each other via a fourth element. Here, the second element may be included in at least one of two or more elements that “are connected or coupled to,” “contact or overlap,” etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can.”

Hereinafter, various embodiments of the present disclosure will be described in detail with reference to accompanying drawings.

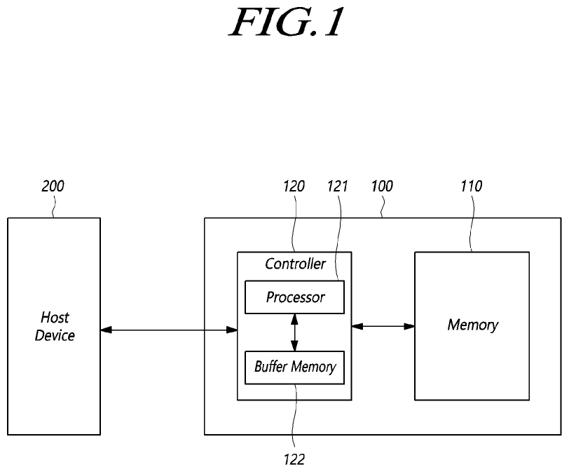

FIG. 1 illustrates a schematic configuration of a storage device 100 according to an embodiment of the disclosed technology.

Referring to FIG. 1, the storage device 100 may include at least one memory 110 and a controller 120 which controls the at least one memory 110.

For example, the memory 110 may be implemented into various types such as a NAND flash memory, a 3D NAND flash memory, a NOR flash memory, a resistive random access memory, a phase-change random access memory, a magnetoresistive random access memory, a ferroelectric random access memory, a spin transfer torque random access memory, and so on. The memory 110 may be implemented into a three-dimensional array structure. The embodiment of the disclosed technology may be applied not only to a flash memory in which a charge storage layer is configured by a floating gate but also to a charge trap flash in which a charge storage layer is configured by an insulating film.

The memory 110 may include a plurality of memory blocks (or storage blocks).

The memory 110 may operate under the control of the controller 120. Operations of the memory 110 may include, for example, a program operation (also referred to as a “write operation”), an erase operation, a read operation, and so on.

The controller 120 may control program, erase, read, and background operations on the memory 110. The background operation may include, for example, at least one among garbage collection, wear leveling, read reclaim, and bad block management operations.

The controller 120 may control the operation of the memory 110 according to a request of a device located outside the storage device 100. Also, the controller 120 may control the operation of the memory 110 regardless of a request from the outside.

For example, the controller 120 may control the operation of the memory 110 according to a request of a host device 200. The storage device 100 and the host device 200 may be collectively referred to as a computing system.

For example, the host device 200 may be a computer, an ultra mobile PC (UMPC), a workstation, a personal digital assistant (PDA), a tablet, a mobile phone, a smartphone, an e-book, a portable multimedia player (PMP), a portable game player, a navigation device, a black box, a digital camera, a digital multimedia broadcasting (DMB) player, a smart television, a digital audio recorder, a digital audio player, a digital picture recorder, a digital picture player, a digital video recorder, a digital video player, a storage configuring a data center, one of various electronic devices configuring a home network, one of various electronic devices configuring a telematics network, an RFID (radio frequency identification) device, a mobility device (e.g., a vehicle, a robot or a drone) capable of driving under human control or autonomous driving, or the like. Alternatively, the host device 200 may be a virtual/augmented reality device which provides a 2D or 3D virtual reality image or augmented reality image. Besides, the host device 200 may be any one of various electronic devices each of which requires the storage device 100 capable of storing data.

The host device 200 may include at least one operating system. The operating system may manage and control overall functions and operations of the host device 200, and may control interoperations between the host device 200 and the storage device 100. The operating system may be classified into a general operating system and a mobile operating system depending on the mobility of the host device 200.

The controller 120 and the host device 200 may be devices which are separated from each other. As the case may be, the controller 120 and the host device 200 may be implemented by being incorporated into one device. Hereunder, for the sake of convenience in explanation, it will be described as an example that the controller 120 and the host device 200 are devices which are separated from each other.

The controller 120 may include a host interface which provides an interface for communication with the host device 200. The controller 120 may include a memory interface which provides an interface for communication with the memory 110.

The controller 120 may include a control circuit which controls overall operations of the controller 120. The control circuit may include a processor 121, as illustrated in FIG. 1. The control circuit may include a working memory which is used for the operation of the processor 121, and as the case may be, may optionally include an error detection and correction circuit.

The processor 121 may communicate with the host device 200 through the host interface, and may communicate with the memory 110 through the memory interface.

The processor 121 may perform a function of interpreting a command input from the host device 200 and transferring the command to the memory 110.

For example, the processor 121 may include a flash translation layer or may correspond to a flash translation layer. The processor 121 may translate a logical block address provided by the host device 200 into a physical block address. The processor 121 may receive a logical block address and translate the logical block address into a physical block address using a mapping table.

The processor 121 may control the operation of the controller 120 by executing, for example, firmware. An operation of the storage device 100 to be described based on the embodiment of the disclosed technology may be implemented in such a way that the processor 121 executes firmware in which the corresponding operation is defined.

Firmware, as a program to be executed in the storage device 100 to drive the storage device 100, may include various functional layers corresponding to the processor 121 described above. For example, the firmware may include binary data in which codes for executing the respective functional layers are defined.

For example, the firmware may be loaded into the working memory from the memory 110 or a separate nonvolatile memory (e.g., a ROM or a NOR Flash) located outside the memory 110. When executing a booting operation after power-on, the processor 121 may first load all or a part of the firmware in the working memory.

In order to control overall operations of the controller 120, the processor 121 may perform a logic operation that is defined in the firmware loaded into the working memory. According to a result of performing the logic operation defined in the firmware, the processor 121 may control the controller 120 to generate a command or a signal. When a part of firmware in which a logic operation to be performed is defined is not loaded in the working memory, the processor 121 may generate an event (e.g., an interrupt) for loading the corresponding part of the firmware in the working memory.

The working memory may store firmware, program codes, commands, or data necessary to drive the controller 120. The working memory may be located inside or outside the controller 120. As the case may be, working memories may be located inside and outside the controller 120.

The working memory may be a buffer memory 122 shown in FIG. 1. Alternatively, the working memory may be disposed separately from the buffer memory 122 shown in FIG. 1. FIG. 1 illustrates, as an example, a case where the buffer memory 122 is located inside the controller 120, but as the case may be, the buffer memory 122 may be located inside or outside the controller 120.

The working memory or the buffer memory 122, which may be a volatile memory, may include at least one among an SRAM (static RAM), a DRAM (dynamic RAM), an SDRAM (synchronous DRAM), and so on.

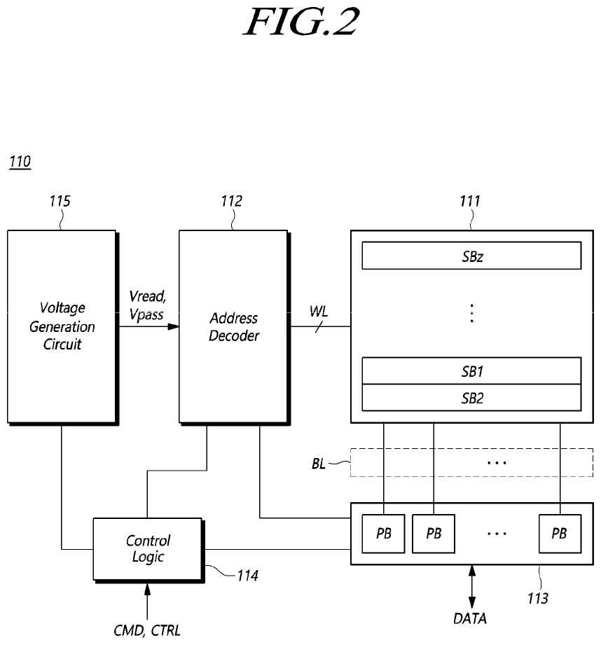

FIG. 2 illustrates a schematic configuration of the memory 110 illustrated in FIG. 1.

Referring to FIG. 2, the memory 110 may include a memory cell array 111, an address decoder 112, a read and write circuit 113, a control logic 114, and a voltage generation circuit 115.

The memory cell array 111 may include a plurality of storage blocks SB1 to SBz (z is equal to 2 or greater than 2).

In the plurality of storage blocks SB, a plurality of word lines WL and a plurality of bit lines BL may be disposed, and a plurality of memory cells may be arranged.

The plurality of storage blocks SB may be coupled with the address decoder 112 through the plurality of word lines WL. The plurality of storage blocks SB may be coupled with the read and write circuit 113 through the plurality of bit lines BL.

Each of the plurality of storage blocks SB may include a plurality of memory cells. The plurality of memory cells may be nonvolatile memory cells, or may be configured with nonvolatile memory cells each of which has a vertical channel structure.

The memory cell array 111 may be configured with a memory cell array of a two-dimensional structure, or may be configured with a memory cell array of a three-dimensional structure.

Each of the plurality of memory cells included in the memory cell array 111 may store at least 1-bit data. For instance, each of the plurality of memory cells included in the memory cell array 111 may be a single-level cell (SLC) which stores 1-bit data. For another instance, each of the plurality of memory cells included in the memory cell array 111 may be a multi-level cell (MLC) which stores 2-bit data. For still another instance, each of the plurality of memory cells included in the memory cell array 111 may be a triple-level cell (TLC) which stores 3-bit data. For yet another instance, each of the plurality of memory cells included in the memory cell array 111 may be a quad-level cell (QLC) which stores 4-bit data. For still yet another instance, the memory cell array 111 may include a plurality of memory cells each of which stores 5 or more-bit data.

The number of bits of data stored in each of the plurality of memory cells may be dynamically determined. For example, a single-level cell which stores 1-bit data may be changed to a triple-level cell which stores 3-bit data.

The address decoder 112, the read and writhe circuit 113, the control logic 114, and the voltage generation circuit 115 may operate as a peripheral circuit which drives the memory cell array 111.

The address decoder 112 may be coupled to the memory cell array 111 through the plurality of word lines WL. The address decoder 112 may be configured to operate under the control of the control logic 114.

The address decoder 112 may receive an address through an input/output buffer in the memory 110. The address decoder 112 may be configured to decode a block address in the received address. The address decoder 112 may select at least one storage block SB according to the decoded block address.

The address decoder 112 may receive a read voltage Vread and a pass voltage Vpass from the voltage generation circuit 115.

In a read voltage applying operation during a read operation, the address decoder 112 may apply the read voltage Vread to a selected word line WL in a selected storage block SB, and may apply the pass voltage Vpass to remaining unselected word lines WL.

In a program verify operation, the address decoder 112 may apply a verify voltage generated by the voltage generation circuit 115 to a selected word line WL in a selected storage block SB, and may apply the pass voltage Vpass to remaining unselected word lines WL.

The address decoder 112 may be configured to decode a column address in the received address. The address decoder 112 may transmit the decoded column address to the read and write circuit 113.

A read operation and a program operation of the memory 110 may be performed on a page basis. An address received when each of the read operation and the program operation is requested may include at least one among a block address, a row address, and a column address.

The address decoder 112 may select one storage block SB and one word line WL according to the block address and the row address, respectively. The column address may be decoded by the address decoder 112 and be provided to the read and write circuit 113.

The address decoder 112 may include at least one among a block decoder, a row decoder, a column decoder, and an address buffer.

The read and write circuit 113 may include a plurality of page buffers PB. The read and write circuit 113 may operate as a read circuit in a read operation of the memory cell array 111, and may operate as a write circuit in a write operation of the memory cell array 111.

The read and write circuit 113 may also be referred to as a page buffer circuit or a data register circuit, which includes the plurality of page buffers PB. The read and write circuit 113 may include data buffers which take charge of a data processing function, and as the case may be, may further include cache buffers which take charge of a caching function.

The plurality of page buffers PB may be coupled to the memory cell array 111 through the plurality of bit lines BL. In a read operation and a program verify operation, the plurality of page buffers PB may continuously supply sensing current to bit lines BL coupled with memory cells to sense threshold voltages (Vth) of the memory cells, and may latch sensing data by sensing, through sensing nodes, that the amounts of current flowing according to the programmed states of the corresponding memory cells are changed.

The read and write circuit 113 may operate in response to page buffer control signals output from the control logic 114.

In a read operation, the read and write circuit 113 may temporarily store read data by sensing data of memory cells, and then, may output data DATA to the input/output buffer of the memory 110. As an exemplary embodiment, the read and write circuit 113 may include a column select circuit and so on in addition to the page buffers PB or the page registers.

The control logic 114 may be coupled with the address decoder 112, the read and write circuit 113, and the voltage generation circuit 115. The control logic 114 may receive a command CMD and a control signal CTRL through the input/output buffer of the memory 110.

The control logic 114 may be configured to control overall operations of the memory 110 in response to the control signal CTRL. The control logic 114 may output control signals for adjusting the precharge potential levels of the sensing nodes of the plurality of page buffers PB.

The control logic 114 may control the read and write circuit 113 to perform the read operation of the memory cell array 111. The voltage generation circuit 115 may generate the read voltage Vread and the pass voltage Vpass used in the read operation, in response to a voltage generation circuit control signal output from the control logic 114.

Each of the storage blocks SB of the memory 110 described above may be configured with a plurality of pages corresponding to a plurality of word lines WL and a plurality of strings corresponding to a plurality of bit lines BL.

In a storage block SB, a plurality of word lines WL and a plurality of bit lines BL may be disposed to intersect with each other. A memory cell may be coupled to one of the plurality of word lines WL and one of the plurality of bit lines BL. A transistor may be disposed in each memory cell.

The transistor disposed in the memory cell may include a drain, a source, and a gate. The drain (or source) of the transistor may be coupled to a corresponding bit line BL directly or via another transistor. The source (or drain) of the transistor may be coupled to a source line (which may be the ground) directly or via another transistor. The gate of the transistor may include a floating gate which is surrounded by a dielectric and a control gate to which a gate voltage is applied from a word line WL.

In each storage block SB, a first select line (also referred to as a source select line or a drain select line) may be additionally disposed outside a first outermost word line WL more adjacent to the read and write circuit 113 between two outermost word lines WL, and a second select line (also referred to as a drain select line or a source select line) may be additionally disposed outside a second outermost word line WL between the two outermost word lines WL.

As the case may be, at least one dummy word line may be additionally disposed between the first outermost word line and the first select line. At least one dummy word line may also be additionally disposed between the second outermost word line and the second select line.

A read operation and a program operation (or write operation) of the storage block SB described above may be performed on a page basis, and an erase operation may be performed on a memory block basis.

A write operation on the storage block SB may be controlled by the controller 120. In order to ensure the reliability of data written to the storage block SB, the controller 120 may write information other than the data to the storage block SB.

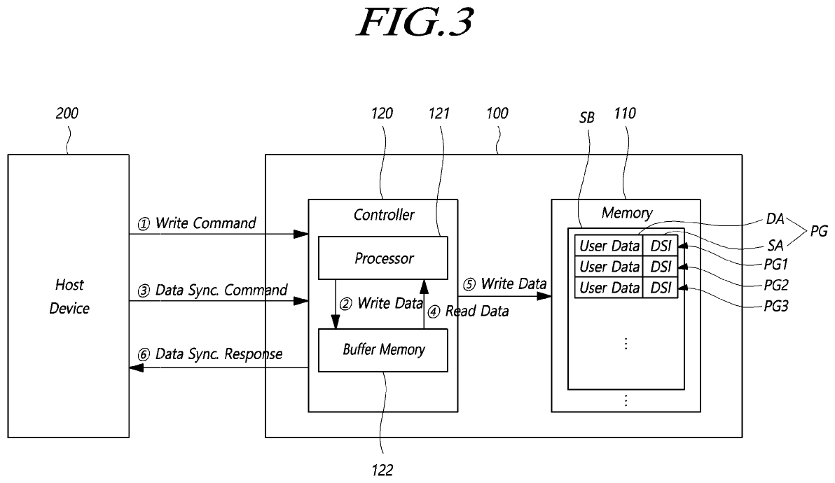

FIG. 3 illustrates an operation of writing data to a memory according to an embodiment. The operation shown in FIG. 3 may be performed by the storage device 100 illustrated in FIG. 1.

Referring to FIG. 3, the controller 120 of the storage device 100 may perform an operation of writing data to the memory 110 according to a write command received from the host device 200.

For example, the host device 200 may manage data on a zone basis. A zone managed by the host device 200 may correspond to at least one storage block SB included in the memory 110.

Since the host device 200 manages data on a zone basis, logical addresses provided by the host device 200 may be mapped to physical addresses of the memory 110 on a block basis. As the case may be, map data may be managed according to a hybrid mapping scheme in which mapping on a block basis and mapping on a page basis are mixed.

The controller 120 may first write user data, according to the write command received from the host device 200, to the buffer memory 122 located either inside or outside the controller 120, and then, may write the user data written to the buffer memory 122 to the memory 110. That is, the user data stored in the buffer memory 122 is transferred or migrated to the memory 110.

All operations performed by the controller 120 may be performed by the processor 121 included in the controller 120. For the sake of convenience in explanation, the operation are described as being performed by the controller 120.

In particular, the controller 120 may receive the write command from the host device 200 (\textcircled{1}). The controller 120 may write the user data to the buffer memory 122 in response to the write command (\textcircled{2}).

Subsequently, the controller 120 may receive a data synchronization command from the host device 200 (\textcircled{3}). The data synchronization command may be distinct from the write command and received separately from the write command. Alternatively, a command or information instructing an operation according to the data synchronization command may be received together with the write command.

Upon receiving the data synchronization command, the controller 120 may read the user data stored in the buffer memory 122 (\textcircled{4}) and write the user data to the memory 110 (\textcircled{5}).

The memory 110 may include the plurality of storage blocks SB, and each of the plurality of storage blocks SB may include a plurality of pages PG. Each of the plurality of pages PG may correspond to one word line WL. Alternatively, when each memory cell is a type of memory cell which stores two or more bits of data, one word line WL may correspond to two or more pages PG.

Each of the plurality of pages PG may include a data area DA and a spare area SA.

The data area DA may be an area to which user data is written. The spare area SA may be an area to which information related to the user data, but distinct from the user data itself, is written.

The controller 120 may write the user data, read from the buffer memory 122, to a data area DA of a page PG in a storage block SB.

When writing the user data to the data area DA in response to the reception of the data synchronization command, the controller 120 may write or set a data synchronization indicator DSI to the spare area DA of the page PG to which the user data is written.

For example, in a case where the user data is written to a data area DA of each of a first page PG1, a second page PG2, and a third page PG3 of a storage block SB in response to the data synchronization command, the data synchronization indicator DSI may be written to a spare area SA of each of the first page PG1, the second page PG2, and the third page PG3.

The data synchronization indicator DSI may be information set to 1 bit, for example.

When the writing of the user data and the data synchronization indicators DSI to the first to third pages PG1 to PG3 of the storage block SB is completed, the controller 120 may transmit a data synchronization response signal to the host device 200 (\textcircled{6}).

By transmitting the data synchronization response signal to the host device 200, the controller 120 can inform the host device 200 that the user data received before receiving the data synchronization command has been written to the memory 110.

By setting the data synchronization indicator DSI for the user data written to the memory 110 upon receiving the data synchronization command, the controller 120 can separately manage the user data written to the memory 110 following the reception of the data synchronization command.

The host device 200 may request a guarantee for the user data that is written to the memory 110 in response to the data synchronization command, and the controller 120 may separately manage the user data for which the guarantee is requested by the host device 200, using the data synchronization indicator DSI.

When the use of the buffer memory 122 is required, the controller 120 may perform an operation of writing the user data stored in the buffer memory 122 to the memory 110 prior to receiving the data synchronization command.

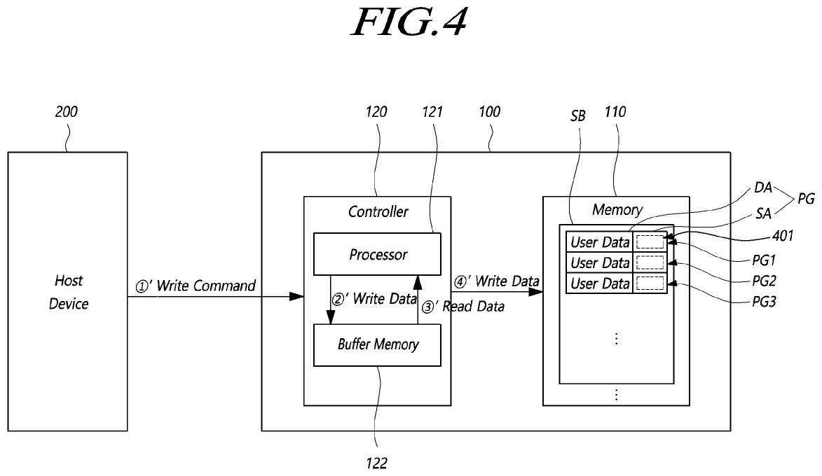

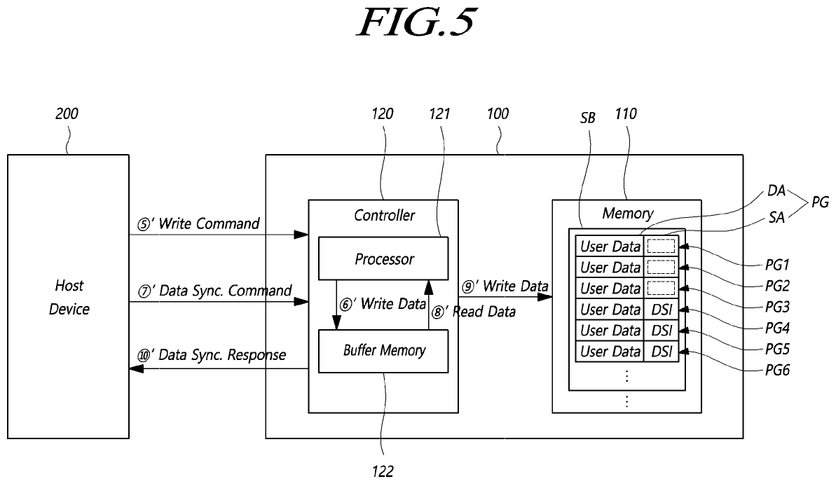

FIGS. 4 and 5 illustrate an operation of writing data to a memory according to another embodiment. The operation shown in FIGS. 4 and 5 may be performed by the storage device 100 illustrated in FIG. 1.

Referring to FIG. 4, the controller 120 of the storage device 100 may receive a write command from the host device 200 (\textcircled{1}′). The controller 120 may write user data to the buffer memory 122 in response to the write command (\textcircled{2}′). For illustrative convenience, the user data will be referred to as ‘first user data.’

The controller 120 may perform an operation of writing the first user data stored in the buffer memory 122 to the memory 110 depending on the state of the buffer memory 122.

For example, when the total size of the first user data stored in the buffer memory 122 is equal to or larger than a preset value, the controller 120 may write the first user data stored in the buffer memory 122 to pages PG of a storage block SB included in the memory 110.

The buffer memory 122 may include an area allocated to user data, and when a proportion of user data stored in the allocated area is equal to or greater than a predetermined level, an operation of writing the user data to the memory 110 may be performed.

Alternatively, the buffer memory 122 may be required to be used for an operation performed by the controller 120. For example, when it is required for the controller 120 to store map data in the buffer memory 122 or write data to the buffer memory 122 according to a background operation, it may be required to secure a space in the buffer memory 122 to perform the corresponding operation. In this case, the controller 120 may perform an operation of writing the entirety or at least a part of user data stored in the buffer memory 122 to the memory 110 to secure the space.

In addition to the above-described examples, when the capacity of the buffer memory 122 is required, the controller 120 may perform an operation of writing user data stored in the buffer memory 122 to the memory 110.

In the above case, the controller 120 may read the first user data stored in the buffer memory 122 (\textcircled{3}′) and write the first user data to data areas DA of pages PG of a storage block SB included in the memory 110 (\textcircled{4}′).

While writing the first user data to the data areas DA of the pages PG, the controller 120 may not set the data synchronization indicator DSI to spare areas SA of the pages PG, as indicated by 401 in FIG. 4.

For example, the controller 120 may not write the data synchronization indicator DSI to the spare areas SA of the pages PG. Alternatively, the controller 120 may write to the spare areas SA of the pages PG a value that is different from the data synchronization indicator DSI written when the data synchronization command is received.

When writing the first user data stored in the buffer memory 122 to the memory 110 without receiving the data synchronization command, the controller 120 may write the first user data without setting the data synchronization indicator DSI. Therefore, the controller 120 can manage the first user data written to the memory 110 without the reception of the data synchronization command, separately from user data for which a guarantee is requested by the host device 200.

Thereafter, the controller 120 may perform an operation of writing user data according to a command received from the host device 200.

Referring to FIG. 5, the controller 120 may receive a write command from the host device 200 (\textcircled{5}′). The controller 120 may write user data corresponding to the write command to the buffer memory 122 (\textcircled{6}′). The user data depicted in FIG. 5 will be referred to as ‘second user data’ to differentiate it from the first user data described in reference to FIG. 4.

Subsequently, the controller 120 may receive a data synchronization command from the host device 200 (\textcircled{7}′). When receiving the data synchronization command, the controller 120 may read the second user data stored in the buffer memory 122 (\textcircled{8}′) and write the second user data to data areas DA of pages PG of a storage block SB included in the memory 110 (\textcircled{9}′).

When writing the second user data to the memory 110 in response to the data synchronization command, the controller 120 may set the data synchronization indicator DSI to spare areas SA of the pages PG to which the second user data is written.

As shown in FIG. 5, in the memory 110, the data synchronization indicator DSI may not be set to spare areas SA of a first page PG1, a second page PG2 and a third page PG3 to which the first user data is written before the data synchronization command is received. After the data synchronization command is received, the data synchronization indicator DSI may be set to spare areas SA of a fourth page PG4, a fifth page PG5 and a sixth page PG6 to which the second user data is written.

When the writing of the second user data and the data synchronization indicator DSI is completed, the controller 120 may transmit a data synchronization response signal to the host device 200 (\textcircled{10}′).

Based on the data synchronization indicator DSI, the controller 120 may separately manage the user data written to the memory 110 according to reception of the data synchronization command. A way in which the data synchronization indicator DSI is set in the memory 110 may vary based on the chosen implementation scheme.

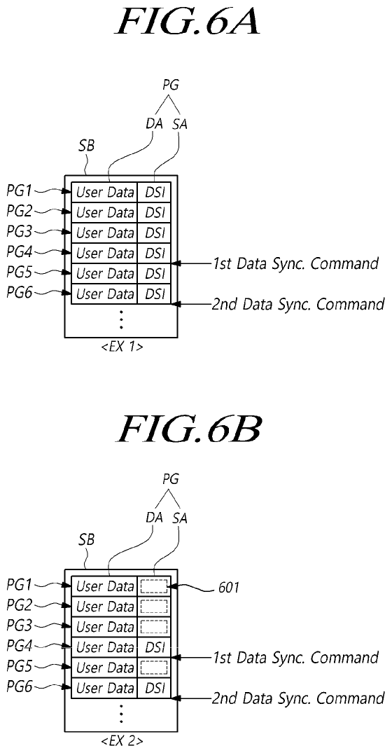

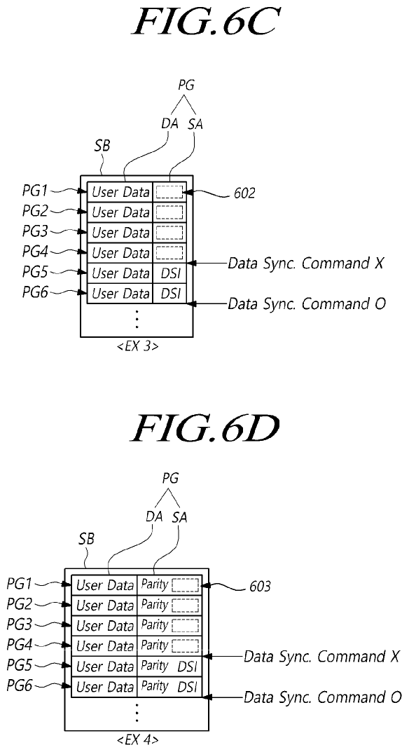

FIGS. 6A to 6D illustrate examples of writing data to respective pages PG of a storage block SB included in the storage device 100 shown in FIG. 1 according to an embodiment of the disclosed technology.

Referring to <EX 1> in FIG. 6A, the data synchronization indicator DSI is written to all pages PG of the storage block SB to which user data is written when a data synchronization command is received.

For example, when receiving a first data synchronization command, the controller 120 may write user data to data areas DA of a first page PG1 to a fourth page PG4. The controller 120 may write the data synchronization indicator DSI to spare areas SA of the first page PG1 to the fourth page PG4.

When receiving a second data synchronization command, the controller 120 may write user data to data areas DA of a fifth page PG5 and a sixth page PG6. The controller 120 may write the data synchronization indicator DSI to spare areas SA of the fifth page PG5 and the sixth page PG6.

That is, whenever a data synchronization command is received, the controller 120 may manage user data by writing the data synchronization indicator DSI to spare areas SA of all pages PG to which the user data is written.

Alternatively, when a data synchronization command is received, the controller 120 may write the data synchronization indicator DSI only to a part of pages PG to which user data is written.

Referring to <EX 2> of FIG. 6B, when receiving a first data synchronization command, the controller 120 may write user data to data areas DA of a first page PG1 to a fourth page PG4. While writing the user data, the controller 120 may write the data synchronization indicator DSI to a spare area SA of the fourth page PG4 that is a last page PG among the first page PG1 to the fourth page PG4. As indicated by 601, the controller 120 may not write the data synchronization indicator DSI to spare areas SA of the first page PG1 to the third pages PG3.

When receiving a second data synchronization command, the controller 120 may write user data to data areas DA of a fifth page PG5 and a sixth page PG6. The controller 120 may not write the data synchronization indicator DSI to a spare area SA of the fifth page PG5, and may write the data synchronization indicator DSI to a spare area SA of the sixth page PG6 that is a last page PG between the fifth page PG 5 and the sixth page PG6.

The controller 120 may separately manage user data for which a guarantee is requested by the host device 200, by writing the data synchronization indicator DSI only to a spare area SA of a last page PG among pages PG to which the user data is written according to a data synchronization command.

Alternatively, a storage block SB may include both a page PG to which the data synchronization indicator DSI is written and a page PG to which the data synchronization indicator DSI is not written. In this case, whether to write the data synchronization indicator DSI to a page PG may be determined depending on a time point at which a data synchronization command is received.

Referring to <EX 3> of FIG. 6C, if user data is written to the memory 110 according to a request to use the buffer memory 122 before a data synchronization command is received, the data synchronization indicator DSI may not be written to a spare area SA of a page PG to which the user data is written.

For example, as indicated by 602, when user data is written to the memory before receiving a data synchronization command, the data synchronization indicator DSI may not be written to spare areas SA of a first page PG1 to a fourth page PG4 to which the user data is written.

On the other hand, when a data synchronization command is received, the data synchronization indicator DSI may be written to spare areas SA of a fifth page PG5 and a sixth page PG6 to which user data is written.

In addition, parity information for ensuring the integrity of user data may be written to a spare area SA to which the data synchronization indicator DSI is written. The parity information may be written separately from the data synchronization indicator DSI.

Referring to <EX 4> of FIG. 6D, as indicated by 603, when user data is written to a data area DA of a page PG before a data synchronization command is received, the data synchronization indicator DSI may not be written to a spare area SA of the corresponding page PG. Even when the data synchronization indicator DSI is not written, parity information which may be used to recover the user data of the corresponding page PG may be written to the spare area SA.

When a data synchronization command is received, the data synchronization indicator DSI may be written to spare areas SA of a fifth page PG5 and a sixth page PG6 to which user data is written, and parity information may also be written to the spare areas SA of the fifth page PG5 and the sixth page PG6. That is, parity information may be written to spare areas SA of all pages PG to which user data is written, and the data synchronization indicator DSI may be written to the spare areas SA of some of the pages PG.

In addition to the examples described above, there may be various cases where the data synchronization indicator DSI is written or set to a spare area SA of a page PG.

By using the data synchronization indicator DSI which is written to a spare area SA of a page PG, the controller 120 may separately manage user data for which a guarantee is requested by the host device 200.

An operation for the controller 120 to manage user data for which the data synchronization indicator DSI is written or set may be variously defined. For example, the data synchronization indicator DSI may be used when controlling a recovery operation resulting from a sudden power-off.

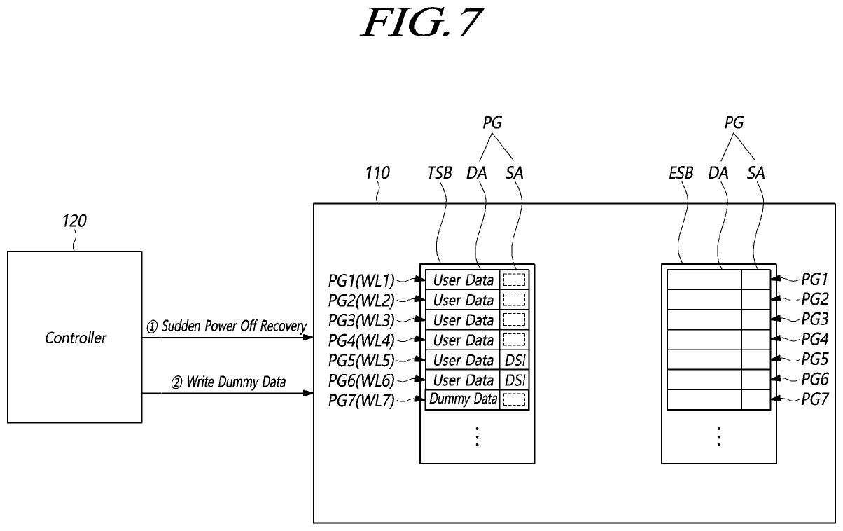

FIGS. 7 to 9 illustrate a recovery operation resulting from a sudden power-off according to an embodiment of the disclosed technology. The recovery operation shown in FIGS. 7 to 9 may be performed by the storage device 100 illustrated in FIG. 1.

Referring to FIG. 7, the sudden power-off may occur during an operation of the storage device 100. As a result of the sudden power-off, the operation of either the controller 120 or the memory 110 may come to a halt. When power is supplied again after the sudden power-off, the controller 120 may perform a recovery operation (\textcircled{1}).

During the recovery operation, the controller 120 may control an operation of writing dummy data to a page PG disposed after a page PG corresponding to a word line WL that was driven before the occurrence of the sudden power-off (\textcircled{2}).

For example, when a storage block SB to which user data is written before the sudden power-off occurs is referred to as a target storage block TSB, the user data may be written to a first page PG1 to a sixth page PG6 of the target storage block TSB, and then, the sudden power-off may occur.

The first page PG1 to the sixth page PG6 may correspond a first word line WL1 to a sixth word line WL6, respectively. FIG. 7 shows, as an example, a case where one page PG corresponds to one word line WL, but the embodiment of the disclosed technology may be applied even to a case where at least two pages PG correspond to one word line WL.

Preceding the sudden power-off, the controller 120, through its write operation control, may activate the sixth word line WL6 included in the target storage block TSB of the memory 110 so that user data may be written to the sixth page PG6.

When it is assumed that the first page PG1 to the fourth page PG4 are pages PG to which user data is written before a data synchronization command is received, the data synchronization indicator DSI may not be written to spare areas SA of the first page PG1 to the fourth page PG4. On the other hand, when it is assumed that the fifth page PG5 and the sixth page PG6 are pages PG to which user data is written after a data synchronization command is received, the data synchronization indicator DSI may be written to spare areas SA of the fifth page PG5 and the sixth page PG6.

In this example, the controller 120 may write dummy data to a seventh page PG7 corresponding to a seventh word line WL7, following the sixth word line WL6, which is last driven before the sudden power-off occurs. In another embodiment, the controller 120 may write dummy data to at least two pages PG.

The controller 120 may not write the data synchronization indicator DSI to a spare area SA of the page PG to which the dummy data is written.

The controller 120 may write dummy data to a predetermined page PG corresponding to a word line subsequent to a word line WL which is a last driven word line before a sudden power-off occurs, and may use subsequent pages PG of the predetermined page PG by writing user data to the subsequent pages PG. The controller 120 may inhibit the utilization of data that has been abnormally written to a page PG as a result of the occurrence of the sudden power-off.

The controller 120 may copy user data written to a page PG corresponding to a word line WL which is last driven before the sudden power-off occurs, to a separate temporary storage block ESB. Copying of the user data may be performed after writing the dummy data, or may be performed before writing the dummy data. Hereinafter, the page PG corresponding to the word line WL which is last driven before the sudden power-off occurs is referred to as a target page PG.

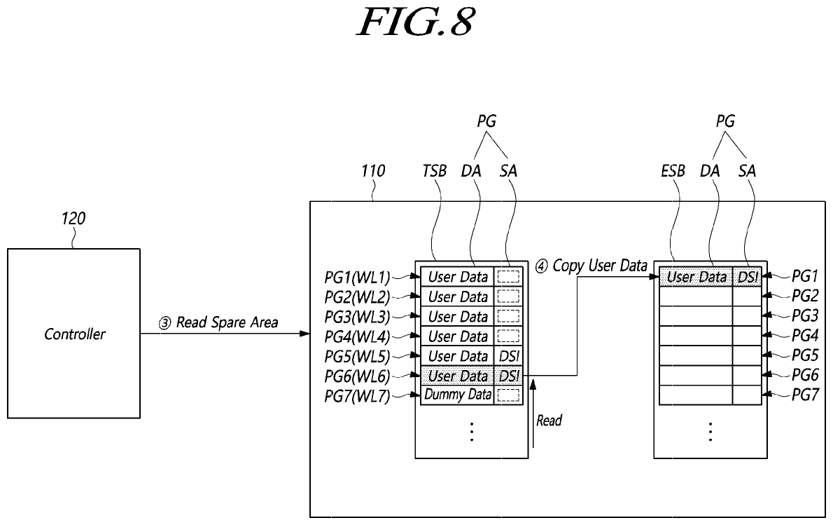

Referring to FIG. 8, when controlling the recovery operation resulting from the sudden power-off, the controller 120 may read a spare area SA of a page PG included in the target storage block TSB (\textcircled{3}).

For example, the controller 120 may read spare areas SA of pages PG included in the target storage block TSB, in the reverse order of the page alignment when the user data has been written following the page alignment. As the case may be, the controller 120 may read data stored in a spare area SA of the target page PG.

The controller 120 may check whether the data synchronization indicator DSI is written to the spare area SA of the target page PG. When the data synchronization indicator DSI is written to the spare area SA of the target page PG, the controller 120 may copy user data, which is stored in a data area DA of the target page PG, to the temporary storage block ESB (\textcircled{4}).

In FIG. 8, the sixth page PG6 may be the target page PC. Therefore, the user data stored in the sixth page PG6 corresponding to the sixth word line WL6, which is the last driven word line before the sudden power-off occurs, may be copied to a first page PG1 of the temporary storage block ESB.

While copying the user data stored in the data area DA of the sixth page PG6 of the target storage block TSB to the temporary storage block ESB, the controller 120 may write the data synchronization indicator DSI to a spare area SA of the first page PG1 of the temporary storage block ESB to which the user data is written.

By copying, to the temporary storage block ESB, the user data stored in the data area DA of the target page PG including the spare area SA to which the data synchronization indicator DSI is written, the controller 120 can provide a guarantee for the user data for which the data synchronization indicator DSI is set, even though the sudden power-off occurs.

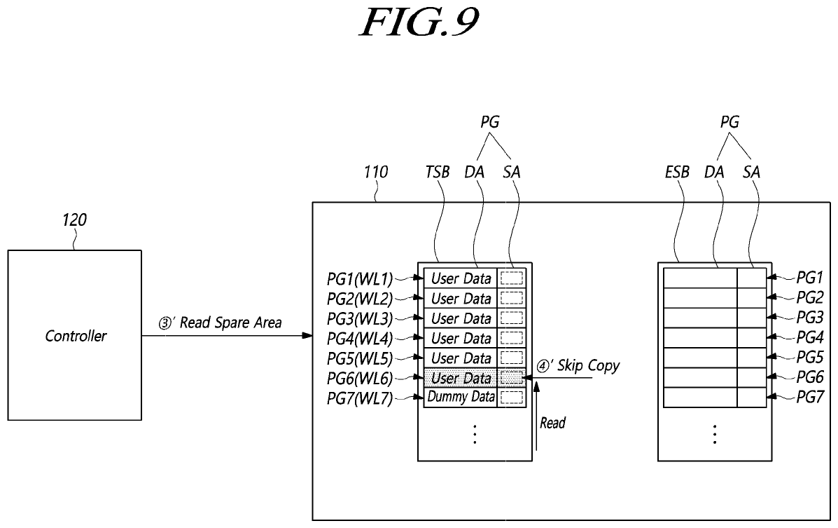

In a case where the data synchronization indicator DSI is not written, the controller 120 may skip copying corresponding user data to the temporary storage block ESB. This will be described with reference to FIG. 9.

Referring to FIG. 9, in order to perform the recovery operation resulting from the sudden power-off, the controller 120 may read data stored in a spare area SA of a page PG included in the target storage block TSB (\textcircled{3}′).

The controller 120 may read spare areas A of pages PG included in the target storage block TSB, in the reverse order. The controller 120 may read data stored in a spare area SA of a page PG that is included in the target storage block TSB and corresponds to a word line WL which is last driven before the sudden power-off occurs.

The controller 120 may read data stored in the spare area SA of the sixth page PG corresponding to the sixth word line WL which is last driven before the sudden power-off occurs. In this example, it is assumed that the data synchronization indicator DSI is not written to the spare area SA of the sixth page PG6.

When the data synchronization indicator DSI is not written to the spare area SA of the sixth page PG6, the controller 120 may not write the user data stored in the data area DA of the sixth page PG6 to the temporary storage block ESB. That is, the controller 120 may skip copying the user data stored in the data area DA of the sixth page PG6 (\textcircled{4}′).

In the case where the controller 120 does not copy the user data of the sixth page PG6 of the target storage block TSB to the temporary storage block ESB, the sixth page PG6 may be managed as an invalid page PG or a page to which user data is not written.

When controlling the recovery operation, by skipping an operation of copying user data of a page PG to which the data synchronization indicator DSI is not written, the controller 120 may reduce a time required for the recovery operation.

By copying, to the temporary storage block ESB, only user data of a page PG to which the data synchronization indicator DSI is written, the controller 120 may provide a guarantee for the user data requested by the host device 200, and may reduce a time required for the recovery operation. While providing a function required by a data synchronization command of the host device 200, the efficiency of the recovery operation may be improved.

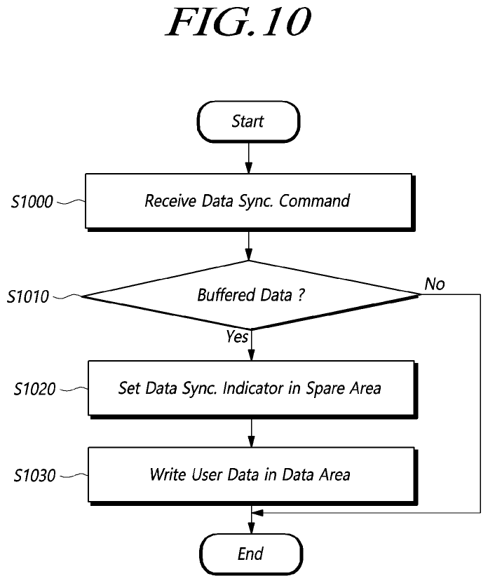

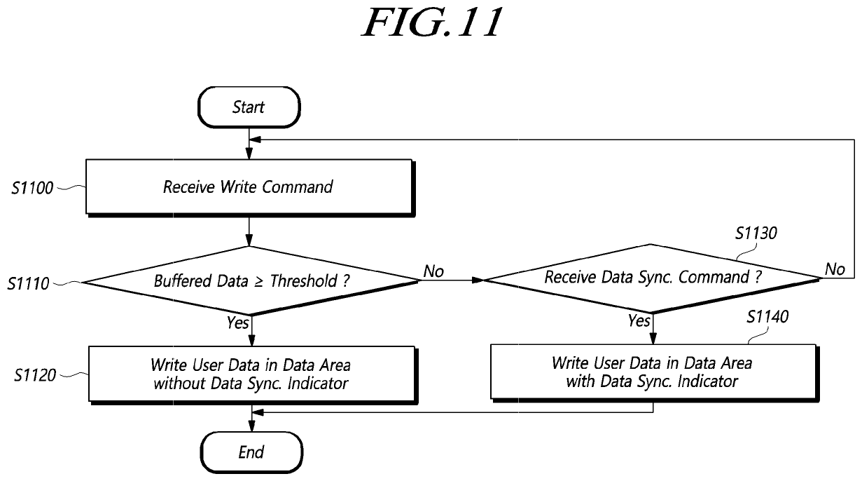

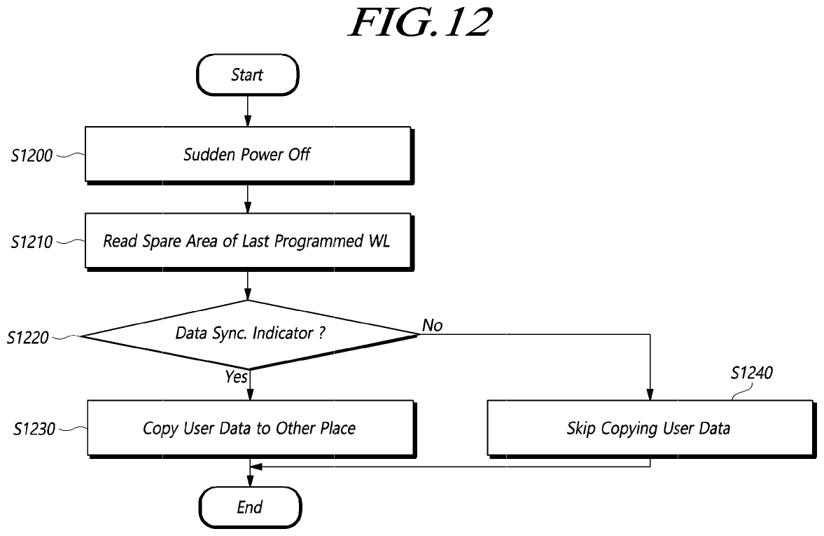

FIGS. 10 and 11 are flowcharts each illustrating a method of writing data to a memory according to an embodiment of the disclosed technology. FIG. 12 is a flowchart illustrating a method of performing a recovery operation resulting from a sudden power-off according to an embodiment of the disclosed technology. These methods will be described with reference to FIG. 1.

Referring to FIGS. 1 and 10, the storage device 100 may receive a data synchronization command from the host device 200 (S1000). When receiving the data synchronization command, the storage device 100 may check whether there is user data stored in the buffer memory 122 (S1010).

When there is user data stored in the buffer memory 122, the storage device 100 may set a data synchronization indicator DSI to a spare area SA of a page PG of a storage block SB included in the memory 110 (S1020), and may write the user data, which is stored in the buffer memory 122, to a data area DA of the page PG (S1030).

The storage device 100 may write the user data stored in the buffer memory 122 to the memory 110 together with the data synchronization indicator DSI in response to the data synchronization command of the host device 200, and may provide a guarantee for the user data requested by the host device 200 according to the data synchronization command.

When writing user data, which is stored in the buffer memory 122, to the memory 110 before receiving a data synchronization command, the storage device 100 may write the user data to the memory 110 without setting the data synchronization indicator DSI.

Referring to FIGS. 1 and 11, the storage device 100 may receive a write command from the host device 200 (S1100).

The storage device 100 may write user data to the buffer memory 122 in response to the write command. The storage device 100 may check whether the total size of user data stored in the buffer memory 122 is equal to or larger than a preset value, i.e., a threshold value (S1110).

When the total size of the user data stored in the buffer memory 122 is equal to or larger than the preset value, the storage device 100 may write the user data stored in the buffer memory 122 to one or more pages PG of the memory 110 without setting the data synchronization indicator DSI (S1120). The data synchronization indicator DSI may not be set or written to spare areas SA of the one or more pages PG of the memory 110 to which the user data is written.

When the total size of the user data stored in the buffer memory 122 is smaller than the preset value, the storage device 100 may check whether a data synchronization command is received (S1130).

As a result of the checking, when the data synchronization command is received from the host device 200, the storage device 100 may write the user data stored in the buffer memory 122 to one or more pages PG of the memory 110 together with the data synchronization indicator DSI (S1140). The user data may be written to data areas DA of the one or more pages PG and the data synchronization indicator DSI is set or written to spare areas SA of the one or more pages PG.

On the other hand, as the result of the checking, when the data synchronization command is not received, the storage device 100 may write next user data to the buffer memory 122 in response to another write command of the host device 200, and may repeatedly perform the above-described operation.

The storage device 100 may provide a guarantee for user data requested by the host device 200, through setting the data synchronization indicator DSI. In addition, by differently controlling at least a part of an operation performed by the storage device 100 is depending on whether the data synchronization indicator DSI is set or not, the operating efficiency of the storage device 100 may be improved while providing a guarantee for user data.

For example, referring to FIG. 12, a sudden power-off may occur during the operation of the storage device 100 (S1200).

In order for a recovery operation resulting from the sudden power-off, the storage device 100 may read data stored in a spare area SA of a target page PG on which a program operation has been performed just before the sudden power-off occurs (S1210). The target page PG corresponds to a word line that is last driven before the sudden power-off occurs.

The storage device 100 may check whether the data synchronization indicator DSI is set or written to the spare area SA of the target page PG that corresponds to the last driven word line WL (S1220).

When the data synchronization indicator DSI is set to the spare area SA of the target page PG, the storage device 100 may copy user data stored in the target page PG to another storage block SB (S1230). On the other hand, when the data synchronization indicator DSI is not set to the spare area SA of the target page PG, the storage device 100 may skip the copying of the user data stored in the target page PG (S1240).

In the recovery operation, whether to copy the user data stored in the target page PG is determined depending on whether the is data synchronization indicator DSI is set or not. Therefore, a guarantee for user data requested by the host device 200 may be provided by setting the data synchronization indicator DSI. By skipping an unnecessary operation of copying the user data when the data synchronization indicator DSI is not set, the efficiency of the recovery operation of the storage device 100 may be improved.

Although various embodiments of the disclosed technology have been described with particular specifics and varying details for illustrative purposes, those skilled in the art will appreciate that various modifications, additions and substitutions may be made based on what is disclosed or illustrated in the disclosed technology without departing from the spirit and scope of the disclosed technology as defined in the following claims.

What is claimed is:

1. A storage device comprising:
a first memory;
a second memory; and
a controller configured to write user data to the first memory in response to a write command from an external device, and write the user data stored in the first memory to the second memory,
wherein when a data synchronization command is received from the external device, the controller writes the user data with a data synchronization indicator to the second memory.

2. The storage device according to claim 1, wherein the second memory includes at least one memory device including a plurality of word lines, a plurality of bit lines, and a plurality of storage blocks; and
wherein the controller writes the user data to data areas of one or more pages included in a target storage block among the plurality of storage blocks and write the data synchronization indicator to a spare area of at least one of the one or more pages upon receiving the data synchronization command.

3. The storage device according to claim 2, wherein the controller writes the data synchronization indicator to a spare area of a last page among the one or more pages to which the user data is written, the last page representing a page on which a program operation is performed most recently among the one or more pages.

4. The storage device according to claim 2, wherein, when a total size of the user data stored in the first memory before receiving the data synchronization command is equal to or larger than a preset value, the controller writes the user data stored in the first memory to the data areas of the one or more pages.

5. The storage device according to claim 2, wherein, when the data synchronization indicator is written to the spare area of the at least one of the one or more pages, the controller transmits a data synchronization response signal to the external device.

6. The storage device according to claim 2, wherein in a recovery operation resulting from a sudden power-off, the controller copies, to a temporary storage block among the plurality of storage blocks, user data stored in a data area of a target page among the one or more pages when the target page includes a spare area where the data synchronization indicator is stored.

7. The storage device according to claim 6, wherein the controller reads the spare areas of the one or more pages included in the target storage block, in a reverse order of the writing of the user data, and copies, to the temporary storage block, the user data stored in the data area of the target page.

8. The storage device according to claim 7, wherein the target page corresponds to a last word line that was activated just before the occurrence of the sudden power-off.

9. The storage device according to claim 6, wherein, when the data synchronization indicator is not stored in the spare area of the target page, the controller skips an operation of copying the user data stored in the data area of the target page to the temporary storage block.

10. The storage device according to claim 8, wherein in the recovery operation, the controller writes dummy data to a next page following the target page, and the dummy data does not include the data synchronization indicator.

11. The storage device according to claim 2, wherein parity information is written to the spare areas of the one or more pages to which the user data is written.

12. A controller comprising:
a buffer memory; and
a processor configured to write user data to the buffer memory in response to a write command, write the user data stored in the buffer memory to an external memory together with a data synchronization indicator when a data synchronization command is received, and write the user data stored in the buffer memory to the external memory without the data synchronization indicator when a total size of the user data stored in the buffer memory is equal to or larger than a preset value before the data synchronization command is received.

13. The controller according to claim 12, wherein in a recovery operation resulting from a sudden power-off, the processor determines whether to copy the user data stored in a target storage block of the external memory to another storage block of the external memory based on whether the user data is written to the external memory together with the data synchronization indicator.

14. A method of operating a storage device, the method comprising:
writing user data to a first memory when a write command is received from a host device; and
writing the user data, stored in the first memory, to a data area of a page included in a target storage block of a second memory; and
writing a data synchronization indicator to a spare area of the page when a data synchronization command is received from the host device.

15. The method according to claim 14, wherein in a recovery operation resulting from a sudden power-off, the method further comprises:
reading a spare area of a target page corresponding to a word line which was activated just before the occurrence of the sudden power-off, wherein the target page stores at least a portion of the user data; and
copying user data stored in a data area of the target page to a temporary storage block of the second memory when the data synchronization indicator is stored in the spare area of the target page.

16. The method according to claim 15, wherein, when the data synchronization indicator is not stored the spare area of the target page, the copying of the user data is skipped.
